(19) United States
(12) Patent Application Publication
(10) Pub. No.: US 2026/0046321 A1
(43) Pub. Date: Feb. 12, 2026

(54) EXTENSION OF A DATA CHANNEL APPLICATION ID WITH A DATA CHANNEL TAG

(71) Applicant: QUALCOMM Incorporated, San Diego, CA (US)

(72) Inventors: Kefeng ZHANG, Beijing (CN); Haris ZISIMOPOULOS, London (GB); Carlos Marcelo Dias PAZOS, Carlsbad, CA (US); Yongze CHEN, San Diego, CA (US)

(21) Appl. No.: 19/100,859

(22) PCT Filed: Sep. 22, 2023
(86) PCT No.: PCT/CN2023/120578

§ 371 Date: Feb. 3, 2025

(30) Foreign Application Priority Data
Sep. 27, 2022 (WO) PCT/CN2022/121622

(51) Int. Cl. H04L 65/1063; H04L 65/1108; H04L 65/65

(52) U.S. Cl. CPC H04L 65/1063; H04L 65/1108; H04L 65/65

(57) ABSTRACT

A method of wireless communication at a UE is disclosed herein. The method includes obtaining (1) information identifying a DC application corresponding to an application associated with the UE and (2) at least one DC tag that is indicative of characteristics of at least one DC from amongst a plurality of DCs associated with the application. The method includes transmitting or receiving data or at least one signal associated with the application via the at least one DC based on the information identifying the DC application and the at least one DC tag.

### CROSS REFERENCE TO RELATED APPLICATION

This application claims the benefit of and priority to Patent Cooperation Treaty (PCT) Application Serial No. PCT/CN2022/121622, entitled “EXTENSION OF A DATA CHANNEL APPLICATION ID WITH A DATA CHANNEL TAG” and filed on Sep. 27, 2022, which is expressly incorporated by reference herein in its entirety.

### TECHNICAL FIELD

The present disclosure relates generally to communication systems, and more particularly, to data channels (DCs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes at least one memory and at least one processor coupled to the at least one memory and, based at least in part on information stored in the at least one memory, the at least one processor, individually or in any combination, is configured to: obtain information identifying a data channel (DC) application that corresponds to an application associated with the UE and at least one DC tag that is indicative of characteristics of at least one DC from amongst a plurality of DCs associated with the application; and transmit or receive data or at least one signal associated with the application via the at least one DC based on the information identifying the DC application and the at least one DC tag.

In an aspect of the disclosure, a method, a computer-readable medium, and an apparatus for wireless communication at a network entity are provided. The apparatus includes at least one memory and at least one processor coupled to the at least one memory and, based at least in part on information stored in the at least one memory, the at least one processor, individually or in any combination, is configured to: obtain information identifying a DC application that corresponds to an application associated with a UE and at least one DC tag that is indicative of characteristics of at least one DC from amongst a plurality of DCs associated with the application; and transmit or receive data or at least one signal associated with the application via the at least one DC based on the information identifying the DC application and the at least one DC tag.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and a UE in an access network.

FIG. 4 is a diagram illustrating example communications between a first UE, a first Internet Protocol Multimedia Subsystem (IMS) application server (AS), a first DC server, a third AS, a second IMS AS, a second DC server, and a second UE.

FIG. 5 is a diagram illustrating an example of a session description protocol (SDP) offer.

FIG. 6 is a diagram illustrating examples of including a DC application identifier and a DC tag in a SDP media description.

FIG. 7 is a diagram illustrating examples of including a DC application identifier and a DC tag in a SDP media description.

FIG. 8 is a diagram illustrating examples of including a DC application identifier and a DC tag in a SDP media description.

FIG. 9 is a diagram illustrating example communications between a UE and a base station.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus.

FIG. 15 is a diagram illustrating an example of a hardware implementation for an example network entity.

### DETAILED DESCRIPTION

An application may support more than one DC for transmission/reception of traffic associated with the application. For example, an augmented reality application (AR) in an IMS DC may support UE-based AR rendering and network based AR rendering. In such an example, a UE may request multiple DCs with different traffic routes for the (same) application. In an example, a route may include a direct DC connection between two UEs, anchoring a DC in a DC server, forwarding DC streams to/from a web real-time communication (RTC) application, or forwarding DC streams to/from an application server (e.g., an AR server). A DC server may determine a corresponding DC control policy for each requested DC. However, a DC application identifier (ID) included in the SDP offer may not include information that indicates characteristics (i.e., routes) of each DC. As such, the DC server may not be able to establish multiple DCs for the DC application based on the DC application ID. The DC server may look up a route selection based on the DC application ID to ascertain a route for each DC. Various technologies pertaining to extending a DC application ID with a DC tag are described herein. In an example, a UE obtains (1) information identifying a DC application that corresponds to an application associated with the UE and (2) at least one DC tag that is indicative of characteristics of at least one DC from amongst a plurality of DCs associated with the application. The UE transmits or receives data or at least one signal associated with the application via the at least one DC based on the information identifying the DC application and the at least one DC tag. Vis-à-vis the at least one DC tag, the multiple DCs may be established for the application without the use of additional signaling and without utilizing a route look up. Thus, the aspects presented herein may conserve network resources.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

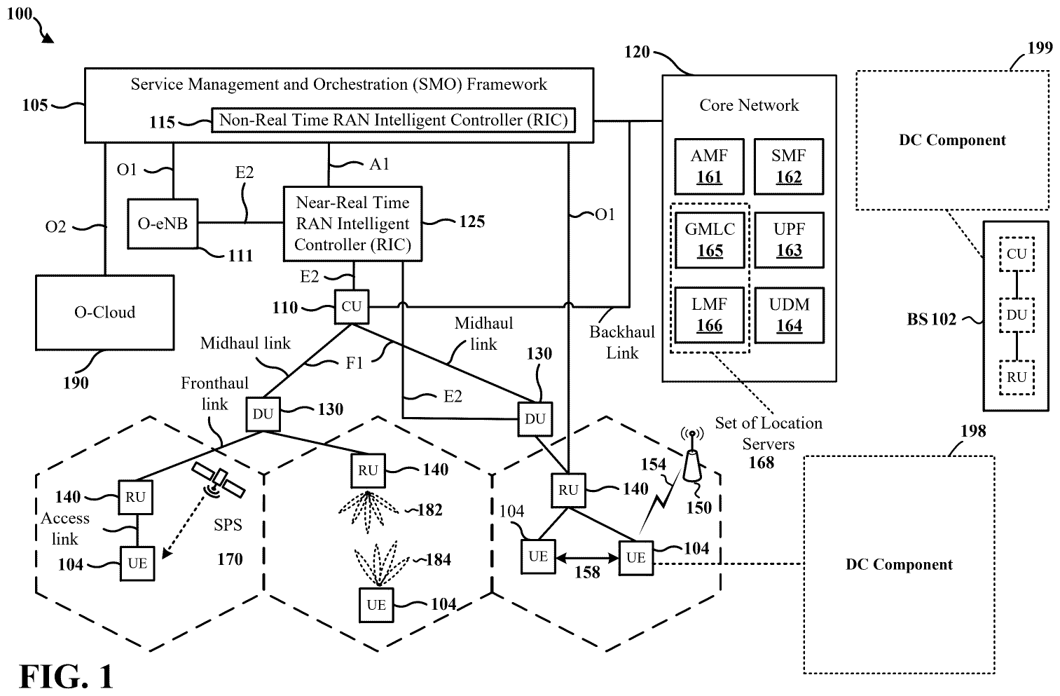

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-CNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a DC component 198 that is configured to obtain (1) information identifying a DC application that corresponds to an application associated with the UE and (2) at least one DC tag that is indicative of characteristics of at least one DC from amongst a plurality of DCs associated with the application; and transmit or receive data or at least one signal associated with the application via the at least one DC based on the information identifying the DC application and the at least one DC tag. In certain aspects, the base station 102 may include a DC component 199 that is configured to obtain (1) information identifying a DC application that corresponds to an application associated with a UE and (2) at least one DC tag that is indicative of characteristics of at least one DC from amongst a plurality of DCs associated with the application; and transmit or receive data or at least one signal associated with the application via the at least one DC based on the information identifying the DC application and the at least one DC tag. Although the following description may be focused on 5G NR, the concepts described herein may be applicable to other similar areas, such as LTE, LTE-A, CDMA, GSM, and other wireless technologies.

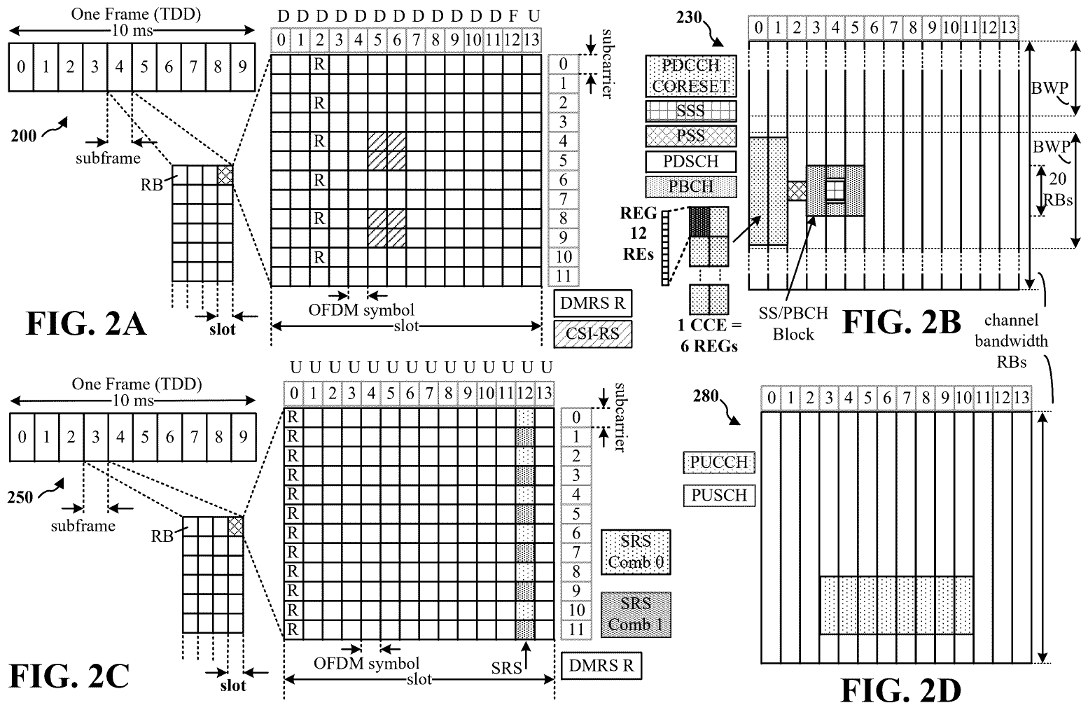

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

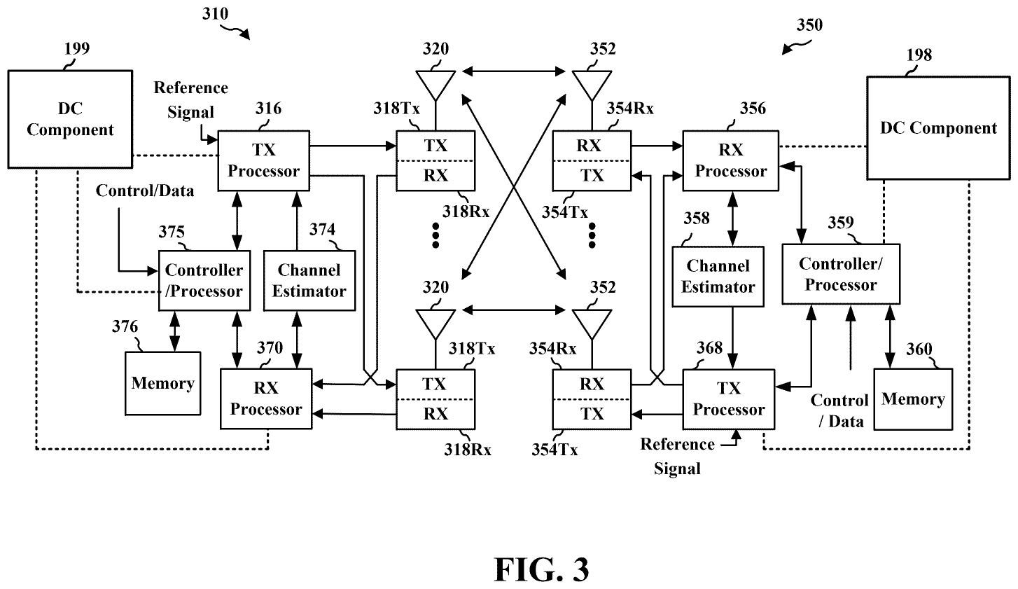

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the DC component 198 of FIG. 1.

At least one of the TX processor 316, the RX processor 370, and the controller/processor 375 may be configured to perform aspects in connection with the DC component 199 of FIG. 1.

Some wireless communication may include XR traffic, such as virtual reality (VR), mixed reality (MR), and/or augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station. XR traffic may be transmitted from one UE and directed to another UE, in some aspects.

An application may support more than one DC for transmission/reception of traffic associated with the application. For example, an AR application in an IMS DC may support UE-based AR rendering and network based AR rendering. In such an example, a UE may request (e.g., in an SDP media description of an SDP offer) multiple DCs with different traffic routes for the (same) application. In an example, a route may include a direct DC connection between two UEs, anchoring a DC in a DC server, forwarding DC streams to/from a web RTC application, or forwarding DC streams to/from an application server (e.g., an AR server). A control function of a data channel server (DCSF) may determine a corresponding DC control policy for each DC requested in the SDP media description. However, a DC application ID included in the SDP offer may not include information that indicates characteristics (i.e., routes) of each DC. As such, the DCSF may not be able to establish multiple DCs based on the DC application ID. The DCSF may look up a route selection based on the DC application ID to ascertain a route for each DC.

Various technologies pertaining to extending a DC application ID with a DC tag are described herein. In an example, a UE obtains (1) information identifying a DC application that corresponds to an application associated with the UE and (2) at least one DC tag that is indicative of characteristics of at least one DC from amongst a plurality of DCs associated with the application. The UE transmits or receives data or at least one signal associated with the application via the at least one DC based on the information identifying the DC application and the at least one DC tag. Vis-à-vis the at least one DC tag, the multiple DCs may be established for the application without the use of additional signaling and without utilizing a route look up. Thus, the aspects of the present disclosure may conserve network resources.

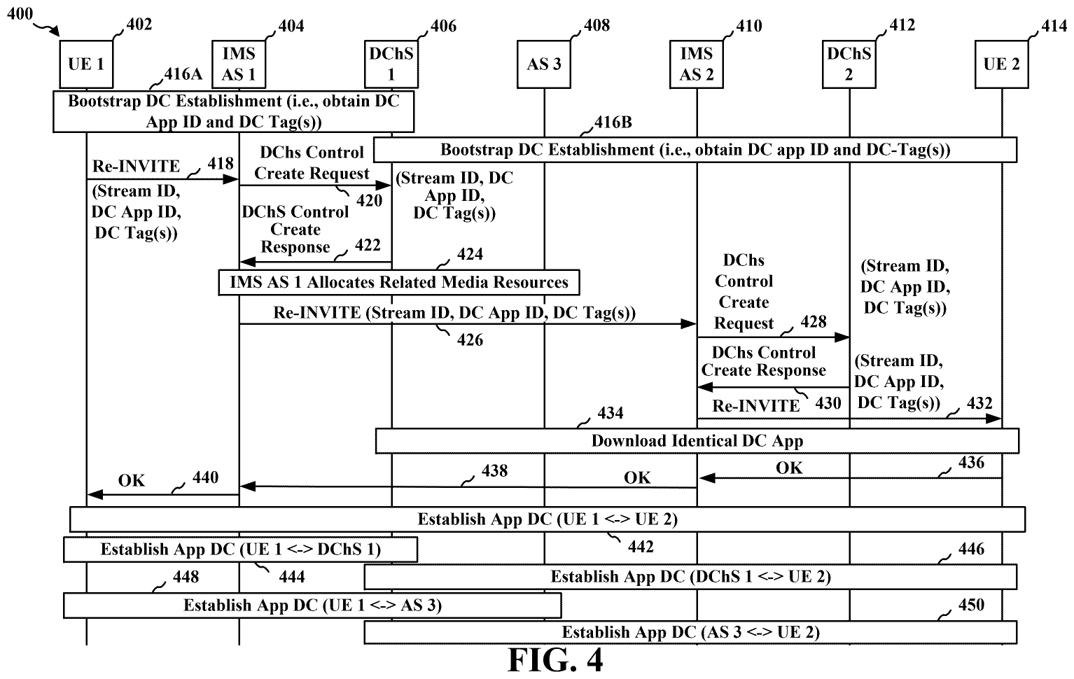

FIG. 4 is a diagram 400 illustrating example communications between a first UE 402, a first IMS AS 404, a first DC server 406 (abbreviated in FIG. 4 as “DChS 1”), a third AS 408, a second IMS AS 410, a second DC server 412 (abbreviated in FIG. 4 as “DChS 2”), and a second UE 414. The term “IMS” may refer to an architectural framework for delivering internet protocol (IP) based multimedia services. IMS may facilitate IP based voice calls, text messages, and multimedia messages for UEs.

A DC server (e.g., the first DC server 406, the second DC server 412, etc.) may include a control function and a media function. The DC server may interact with an IMS AS (e.g., the first IMS AS 404, the second IMS AS 410, etc.). The control function may implement data channel business logic and the media function may execute IMS data channel media operations. The DC server may also receive DC applications from users or authorized parties, store DC applications in a DC application repository, manage data channels with data channel multimedia telephony service for IMS (DCMTSI) clients according to a request from the IMS AS, distribute or update DC applications via established bootstrap data channels to the DCMTSI clients, route DC application traffic between DCMTSI clients and application servers, and generate traffic usage reports and event reports. The first UE 402 and/or the second UE 414 may be DCMTSI UEs.

At 416A, a bootstrap DC may be established for the first UE 402. At 416B, a bootstrap DC may be established for the second UE 414. A bootstrap DC may refer to a data channel that is used to transfer a DC application list and/or a DC application between a UE and a network. A bootstrap DC may be based on hypertext transfer protocol (HTTP). The bootstrap DC may be associated with a stream identifier (ID) that may be an integer that is less than 1000. In an example, the first UE 402 may download a DC application via the bootstrap DC. The DC application may include hypertext markup language (HTML) web content, and optionally image(s) and style sheet(s). The DC application may be accessible at an HTTP root uniform resource locator (URL) through a bootstrap DC. The DC application may describe a graphical user interface (GUI) and interactive service logic. In an example, the DC application may be an AR application that supports network-based AR rendering and UE-based AR rendering. The first UE 402 (and/or the second UE 414) may obtain a DC application ID and at least one DC tag when the DC application is downloaded.

The DC application ID may be a unique identifier that identifies the DC application in an IMS network. The DC application ID may be included in an SDP media description of a SDP offer as an optional line that identifies an association of a DC with a serving application. The DC application ID may be allocated by an IMS network provider. The DC application ID may include a public land mobile network (PLMN) ID (including a mobile network code (MNC) and a mobile country code (MCC)), an indication of a DC application provider (e.g., a user or a network provider), a DC application number allocated by the network provider, an optional DC application name (e.g., a human readable name), a uniform resource indicator (URI) of the DC application stored in a DC server or a DC application repository, and an indication as to whether the DC application ID is allocated by a third party or an high level operating system (HLOS).

A DC tag may identify characteristics of each DC associated with the DC application. A DC tag may be unique for a DC application. “DC tag” is merely one example of a name for the information, which may be referred to by other names than “DC tag,” such as a DC label, DC identifier, identifying information for the DC, etc. in other examples. The DC tag may be allocated by a developer of the DC application or by a mobile network operator (MNO). The characteristics may refer to a route or routes associated with the DC. The route(s) may include a direct connection between UEs (e.g., a direct connection between the first UE 402 and the second UE 414), anchoring DCs in a DC server (e.g., the first DC server 406, the second DC server 412), forwarding DC streams to/from third party web RTC applications, and/or forwarding DC streams to/from an application server (e.g., the first IMS AS 404, the second IMS AS 410, the third AS 408, etc.). The DC application ID and DC tag(s) may be included in an SDP media description of a SDP offer by specifying attributes for the DC application ID and the DC tag(s). A DC tag may be indicated by a “dcmap” line. An example of a DC attribute for a DC application ID may be “a=dcapp-id=” DC Application #1.”

At 418, the first UE 402 may transmit an SDP offer for establishing a DC (or DCs) for the DC application (referred to in FIG. 4 as a “Re-INVITE”) to the first IMS AS 404. The SDP offer may include the stream ID, the DC application ID, and the DC tag(s) in an SDP media description of the SDP offer. A manner in which a DC application and a DC tag are offered and selected in an SDP offer may be defined in a specification.

At 420, upon receiving the SDP offer, the first IMS AS 404 may send a service request (referred to in FIG. 4 as “DChs control create request”) with the DC application ID and the DC tag(s) to a signaling function of the first DC server 406 for creation of the DC. If the DC application is a local application, the first DC server 406 may determine a DC control policy (e.g., a route) of the DC based on an application profile associated with the DC application. If the service request is to open a remote application for the first UE 402, the first DC server 406 may reject the service request. If the DC application ID is not included in the SDP offer, the first DC server 406 may determine a route selection based on an MNO policy (e.g., a direct DC connection between DCMTSI UEs).

At 422, the signaling function of the first DC server 406 may send a service response (referred to in FIG. 4 as “DChS Control Crate Response”) with the DC control policy to the first IMS AS 404. At 424, the first IMS AS 404 may request a DC media function to allocate related media resources for the DC. The first IMS AS 404 may also establish a media connection with the third AS 408. In an example, the third AS 408 may be an AR application server or a third party web RTC server.

At 426, the first IMS AS 404 may transmit an SDP offer (referred to in FIG. 4 as “Re-INVITE”) to the second IMS AS 410. The SDP offer may include the stream ID, the DC application ID, and the DC tag(s) in an SDP media description. At 428, the second IMS AS 410 may send a service request (referred to in FIG. 4 as “DChs control create request”) to a signaling function of the second DC server 412 for creation of the DC. If the second DC server 412 determines that the DC application ID is not associated with a local application, the second DC server 412 may not anchor a DC. At 430, the second DC server may send a service response (referred to in FIG. 4 as “DChs control crate response”) with the DC control policy.

At 432, the second IMS AS 410 may transmit a SDP offer (referred to in FIG. 4 as “Re-INVITE”) that includes the stream ID, the DC application ID, and the DC tag(s) to the second UE 414. At 434, if the second UE 414 accepts the DC application, the second UE 414 may determine whether the DC application is instantiated. If the DC application is not instantiated, the second UE 414 may request a download of the DC application via a bootstrap DC (e.g., the bootstrap DC established at 416B). In an example, if the DC application ID is not included in the SDP offer, the second UE 414 may have already instantiated the DC application (e.g., the DC application may be preconfigured or the second UE 414 may have downloaded available DC applications from DC servers).

At 436, the second UE 414 may transmit an OK message (e.g., “200 OK”) to the second IMS AS 410. At 438, the second IMS AS 410 may transmit an OK message (e.g., “200 OK”) to the first IMS AS 404. At 440, the first IMS AS 404 may transmit an OK message (e.g., “200 OK”) to the first UE 402.

At 442, a DC for the DC application may be established between the first UE 402 and the second UE 414 according to a DC route configuration instruction from the first DC server 406, where the DC route configuration instruction may be based on the DC application ID and the DC tag(s) included in the SDP media description of the SDP offer. At 444, a DC for the DC application may be established between the first UE 402 and the first DC server 406 according to the DC route configuration. At 446, a DC for the DC application may be established between the first DC server 406 and the second UE 414 according to the DC route configuration. At 448, a DC for the DC application may be established between the first UE 402 and the third AS 408 according to the DC route configuration. At 450, a DC for the DC application may be established between the third AS 408 and the second UE 414 according to the DC route configuration.

The communications depicted in the diagram 400 illustrate various advantages for DC servers and UEs. For instance, a DC server may be enhanced in order to retrieve and/or allocate a DC application ID and DC tag(s) associated with a DC application when the DC application is provided and uploaded to a DC application repository. The DC server may be further enhanced to retrieve and store a DC application profile in a DC server. The DC server may also deliver the DC application ID and the DC tag(s) associated with the DC application when a UE downloads a DC application list or when the UE downloads the DC application. The DC server may also determine a DC control policy (e.g., a route) according to the DC application ID and the DC tag(s) associated with the DC application. In another example, the UE may add a DC application ID and DC tag(s) in a SDP offer when initiating a SDP negotiation for a DC. Furthermore, the UE may trigger downloading of a DC application via a bootstrap DC. The UE may associate DC traffic with each DC for the DC application.

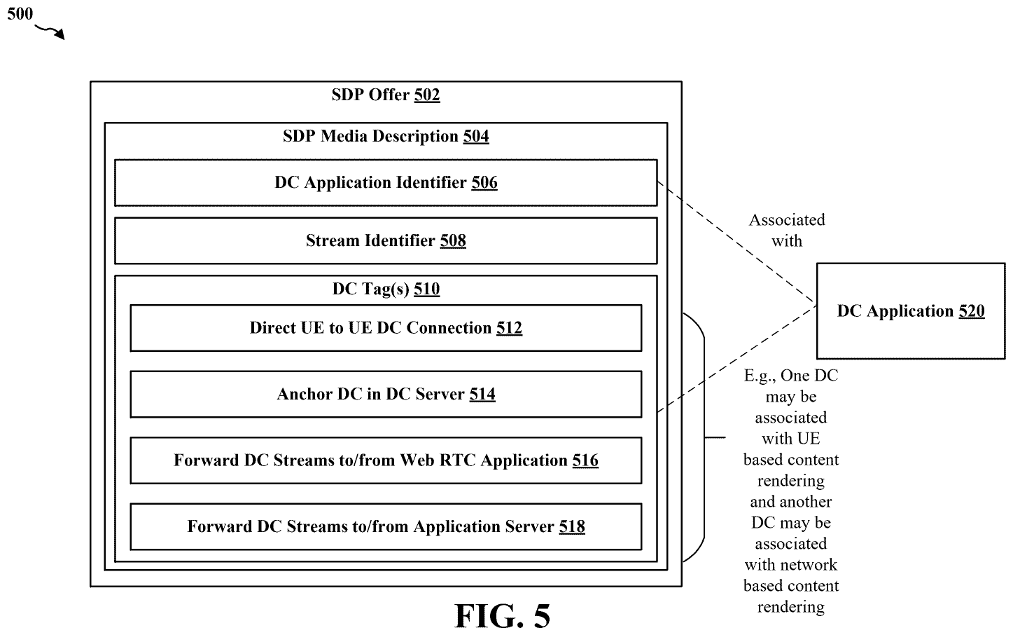

FIG. 5 is a diagram 500 illustrating an example of a SDP offer 502. The SDP offer 502 may be the SDP offer described above in the description of FIG. 4. The SDP offer 502 may include a SDP media description 504. The SDP media description 504 may include a DC application identifier 506, a stream identifier 508, and one or more DC tags 510.

The application identifier 506 may be a unique identifier that identifies a DC application 520 in an IMS network. The DC application identifier 506 may be an optional line that identifies an association of a DC with a serving application. The DC application identifier 506 may be allocated by an IMS network provider. The DC application identifier 506 may include a PLMN ID (including a MNC and a MCC), an indication of a DC application provider (e.g., a user or a network provider), a DC application number allocated by the network provider, an optional DC application name (e.g., a human readable name), a URI of the DC application 520 stored in a DC server or a DC application repository, and an indication as to whether the DC application identifier 506 is allocated by a third party or a HLOS. The stream identifier 508 may identify a stream associated with a bootstrap DC associated with the DC application 520.

The one or more DC tags 510 may identify characteristics of each DC associated with the DC application 520. The one or more DC tags 510 may be allocated by a developer of the DC application or by a MNO. The characteristics may refer to a route or routes associated with each DC. In an example, the one or more DC tags 510 may indicate a direct UE to UE (e.g., the first UE 402 and the second UE 414) DC connection 512, anchoring a DC in a DC server 514 (e.g., the first DC server 406, the second DC server 412), forwarding DC streams to/from a third party web RTC application 516, and/or forwarding DC streams to/from an application server 518 (e.g., the first IMS AS 404, the second IMS AS 410, the third AS 408). The one or more DC tags 510 may indicate a fully qualified domain name (FQDN) of the application server. The DC server may include a data channel server-media (DCS-M) function, a data channel media function (DCMF), or a media resource function (MRF). The one or more DC tags 510 may be indicated by a “dcmap” line of the SDP media description 504. An example of a DC attribute for a DC application ID may be “a=dcapp-id=” DC Application #1.”

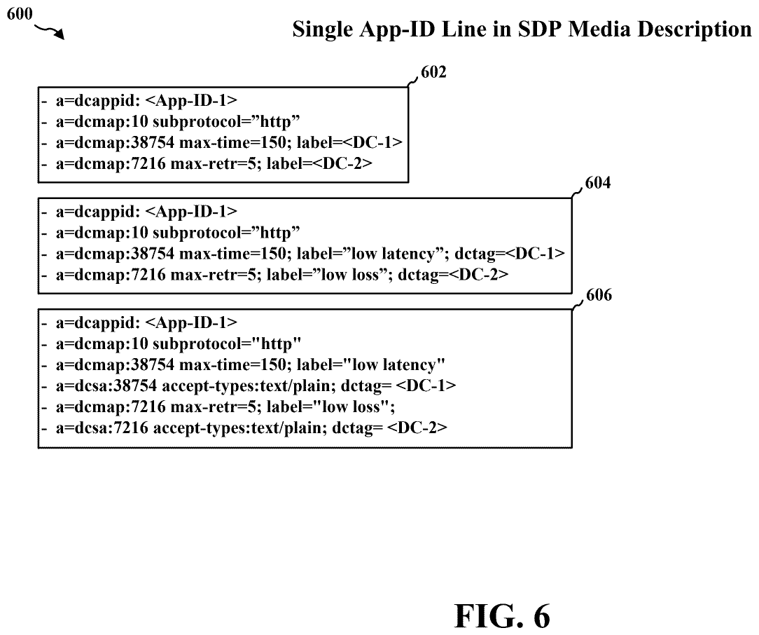

FIG. 6 is a diagram 600 illustrating examples of including a DC application identifier and a DC tag in a SDP media description. The diagram 600 includes a first example 602, a second example 604, and a third example 606. When a DC SDP media description has a 1:1 mapping with a DC application, a single line of a SDP attribute may be used to indicate the DC application ID. If multiple DCs are supported by a DC application, parameters that indicate characteristics of the multiple DCs may be included in a “a=dcmap” line or an associated “a=dcsa” line of the SDP media description. The abbreviation “dcmap” may refer to a data channel media attribute. The abbreviation “dcsa” may refer to a data channel subprotocol attribute.

In the first example 602, the DC application ID may be indicated by “a=dcappid: <App-ID-1>.” DC tags may be indicated by using an optional “label” parameter. For instance, the DC tags may be indicated by “label=<DC-1>” and “label=<DC-2>.”

In the second example 604, the DC application ID may be indicated by “a=dcappid: <App-ID-1>.” The DC tags may be indicated by creating a new parameter in a “a=dcmap” line. For instance, the DC tags may be indicated by “dctag=<DC-1>” and “dctag=<DC-2>.”

In the third example 606, the DC application ID may be indicated by “a=dcappid: <App-ID-1>.” The DC tags may be indicated by creating a new parameter in a “a=dcsa” line. For instance, the DC tags may be indicated by “dctag=<DC-1>” and “dctag=<DC-2>” in “a=dcsa” lines.

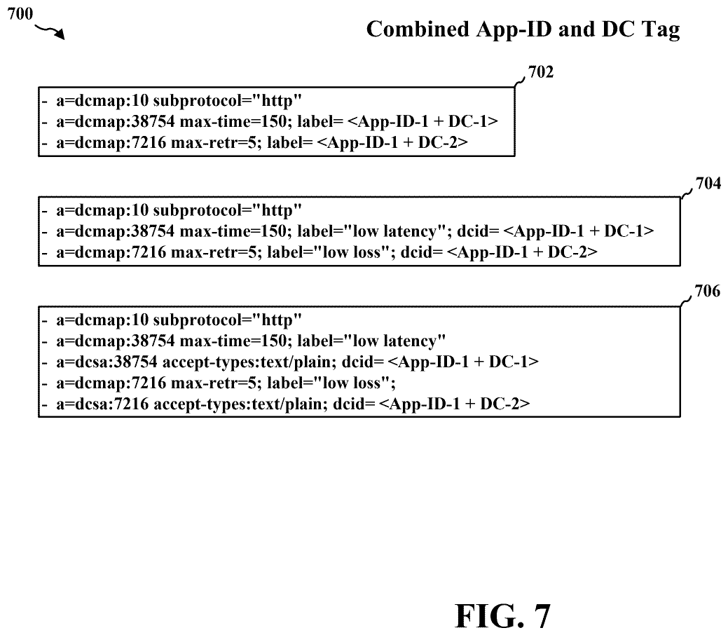

FIG. 7 is a diagram 700 illustrating examples of including a DC application identifier and a DC tag in a SDP media description. The diagram 700 includes a first example 702, a second example 704, and a third example 706. In the diagram 700, the DC application ID and the DC tag(s) may be combined.

In the first example 702, the DC application ID and the DC tags may be combined as a parameter using an optional label parameter. For instance, the DC application ID and the DC tag(s) may be indicated by “label=<App-ID-1+DC-1>” and “label=<App-ID-1+DC-2>.”

In the second example 704, the DC application ID and the DC tags may be combined by creating a new parameter in a “a-dcmap” line. For instance, the DC application ID and the DC tag(s) may be indicated by “dcid=<App-ID-1+DC-1>” and dcid=<App-ID-1+DC-2>” in “a=dcmap” lines.

In the third example 706, the DC application ID and the DC tags may be combined by creating a new parameter in a “a-dsca” line. For instance, the DC application ID and the DC tag(s) may be indicated by “dcid=<App-ID-1+DC-1>” and dcid=<App-ID-1+DC-2>” in “a=dcsa” lines.

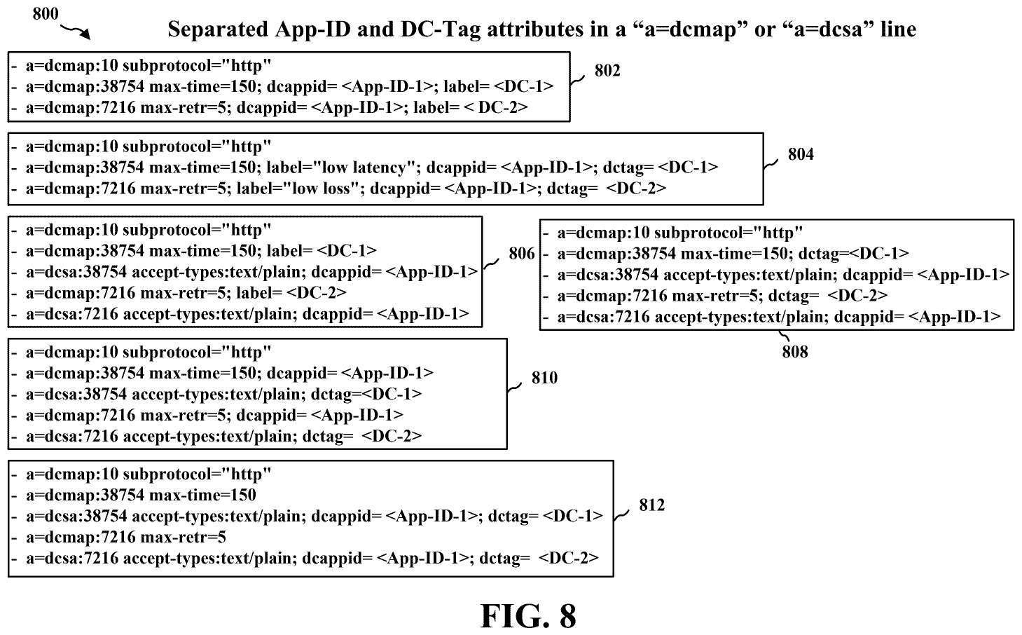

FIG. 8 is a diagram 800 illustrating examples of including a DC application identifier and a DC tag in a SDP media description. The diagram 800 includes a first example 802, a second example 804, a third example 806, a fourth example 808, a fifth example 810, and a sixth example 812. In the diagram 800, the DC application ID and the DC tag(s) may be indicated by separate attributes in a “a=dcmap” line or a “a-dcsa” line.

In the first example 802, the DC application ID and the DC tags may be separated. For instance, the DC application ID may be indicated by “dcappid=<App-ID-1>” and the DC tags may be indicated by reusing label parameters in separate lines: “label=<DC-1>” and “label=<DC-2>.”

In the second example 804, the DC application ID and the DC tags may be separated. For instance, the DC application ID may be indicated by “dcappid=<App-ID-1>” and the DC tags may be indicated by using a new parameter (“dctag=<DC-1>” and “dctag=<DC-2>”) in a “a=dcmap” line.

In the third example 806, the DC application ID and the DC tags may be separated. For instance, the DC application ID may be indicated by “dcappid=<App-ID-1>” in “a=dcsa” lines and the DC tags may be indicated by reusing label parameters (“label=<DC-1>” and “label=<DC-2>”) in “a=dcmap” lines

In the fourth example 808, the DC application ID and the DC tags may be separated. For instance, the DC application ID may be indicated by “dcappid=<App-ID-1>” in “a=dcsa” lines and the DC tags may be indicated by using a new parameter (“dctag=<DC-1>” and “dctag=<DC-2>”) in “a=dcmap” lines.

In the fifth example 810, the DC application ID and the DC tags may be separated. For instance, the DC application ID may be indicated by “dcappid=<App-ID-1>” in “a=dcmap” lines and the DC tags may be indicated by using a new parameter (“dctag=<DC-1>” and “dctag=<DC-2>”) in “a=dcsa” lines.

In the sixth example 812, the DC application ID and the DC tags may be separated. For instance, the DC application ID may be indicated by “dcappid=<App-ID-1>” in “a=dcsa” lines and the DC tags may be indicated by a new parameter (“dctag=<DC-1>” and “dctag=<DC-2>”) in the “a=dcsa” lines.

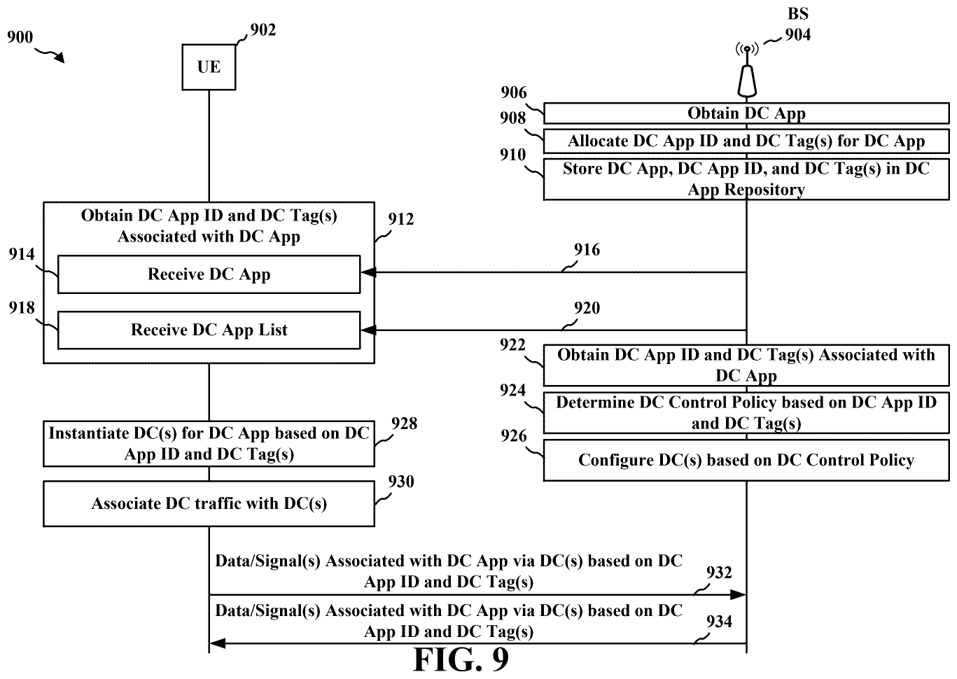

FIG. 9 is a diagram 900 illustrating example communications between a UE 902 and a base station 904. In an example, the UE 902 may be the UE 104, the UE 350, the first UE 402, the second UE 414, or the apparatus 1404. In an example, the base station 904 may be the base station 102, the base station 310, or the network entity 1502. In an example, the base station 904 may be associated with the first DC server 406 or the second DC server 412. The base station 904 may be associated with a DC application repository.

At 906, the base station 904 may obtain a DC application (e.g., the DC application 520). The DC application may include support for transmission/reception of data/signals via one or more DCs. In an example, the DC application may be an AR application that supports UE-based rendering of first content via a first DC and network based rendering of second content via a second DC. In an example, the base station 904 may receive the DC application from a developer of the DC application. For instance, the DC application may be uploaded to a DC server associated with the base station 904. In another example, the base station 904 may obtain an updated version of the DC application from the developer of the DC application.

At 908, the base station 904 may allocate a DC application ID and one or more DC tags associated with the application. The DC application ID and the one or more DC tags may be allocated when the DC application is initially obtained or when the DC application is updated. The DC application ID may be the DC application identifier 506 described above. The one or more DC tags may be or include some or all of the one or more DC tags 510 described above. At 910, the base station 904 may store the DC application, the DC application ID, and the one or more DC tags in a DC application repository. In one aspect, a DC server associated with the base station 904 may maintain a DC application profile associated with the DC application, which may indicate characteristics of the DC application, associated DC tags, and traffic route policies for DCs associated with the DC application.

At 912, the UE 902 may obtain the DC application ID and the one or more DC tags associated with the DC application. In an example, the UE 902 may obtain the DC application ID and the one or more DC tags via a bootstrap DC. In one example, at 914, the UE 902 may receive the DC application via the bootstrap DC, where the DC application may include the DC application identifier and the one or more DC tags. For instance, at 916, the base station 904 may transmit the DC application, the DC application identifier, and the one or more DC tags to the base station 904. In another example, at 918, the UE 902 may receive a DC application list via the bootstrap DC, where the DC application list may include the DC application identifier and the one or more DC tags (as well as DC application identifiers and DC tags for other DC applications). For instance, at 920, the base station 904 may transmit the DC application list to the UE 902. In another example, the UE 902 may receive signaling (e.g., via the bootstrap DC) that indicates the DC application ID and the one or more DC tags when the DC application is downloaded. In yet another example, the UE 902 may receive (e.g., via the bootstrap DC) the DC application ID and the one or more DC tags in a DC application package. In a further example, the UE 902 may obtain the DC application ID and the one or more DC tags from another UE. In an example, the UE 902 may obtain the DC application ID and the one or more DC tags in a SDP offer (e.g., the SDP offer 502).

At 922, the base station 904 may obtain the DC application identifier and the one or more DC tags associated with the DC application. In an example, the base station 904 may obtain the DC application ID and the one or more DC tags in a SDP offer (e.g., the SDP offer 502) transmitted by the UE 902. At 924, the base station may determine a DC control policy (or DC control policies) based on the DC application identifier and the one or more DC tags. At 926, the base station 904 may configure the one or more DCs based on the DC control policy. In an example, configuring the one or more DCs may include aspects related to establishing the DCs at 442, 444, 446, 448, and/or 450 in FIG. 4.

At 928, the UE 902 may instantiate the one or more DCs for the DC application based on the DC application identifier and the one or more DC tags. In an example, instantiating the one or more DCs may include aspects related to establishing the DCs at 442, 444, 446, 448, and/or 450 in FIG. 4. At 930, the UE 902 may associate DC traffic with the one or more DCs. When the UE 902 and a second UE, a DC server, and/or an application server have instantiated the DCs, data transmission on the DCs may begin.

At 932, the UE 902 may transmit data/signals associated with the DC application via the one or more DCs based on the DC application identifier and the one or more DC tags. At 934, the UE 902 may receive data/signals associated with the DC application via the one or more DCs based on the DC application identifier and the one or more DC tags

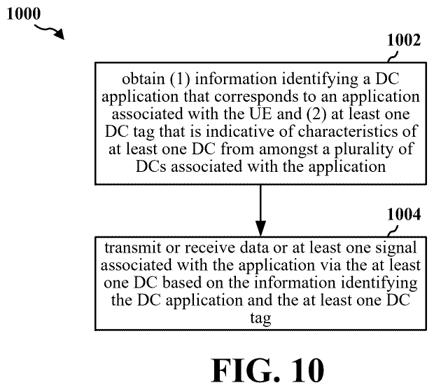

FIG. 10 is a flowchart 1000 of a method of wireless communication. The method may be performed by a UE (e.g., the UE 104, the UE 350, the first UE 402, the second UE 414, the UE 902, the apparatus 1404). The method may be associated with various advantages at the UE, such as more efficient negotiation and establishment of DC(s) for an application vis-à-vis a DC tag. In an example, the method may be performed by the DC component 198.

At 1002, the UE obtains (1) information identifying a DC application that corresponds to an application associated with the UE and (2) at least one DC tag that is indicative of characteristics of at least one DC from amongst a plurality of DCs associated with the application. For example, FIG. 9 at 912 shows that the UE 902 may obtain a DC app ID (e.g., “information identifying a DC application”) and DC tag(s) that are associated with a DC app. In an example, the application may be the DC application 520. In another example, the at least one DC tag may include the one or more DC tags 510. In yet another example, the UE may obtain the DC application identifier (e.g., “information identifying a DC application”) and the at least one tag when a bootstrap DC is established as illustrated at 416A or 416B in FIG. 4. In a further example, the UE may obtain the DC application identifier (e.g., “information identifying a DC application”) and the at least one tag at 432 as illustrated in FIG. 4. In an example, 1002 may be performed by the DC component 198.

At 1004, the UE transmits or receives data or at least one signal associated with the application via the at least one DC based on the information identifying the DC application and the at least one DC tag. For example, FIG. 9 at 932 shows that the UE 902 may transmit data/signal(s) associated with a DC application via DC(s) based on a DC app ID and DC tag(s). In another example, FIG. 9 at 934 shows that the UE 902 may receive data/signal(s) associated with a DC application via DC(s) based on a DC app ID and DC tag(s). In yet another example, the UE may transmit or receive the data or the at least one signal via one of the DCs established at 442, 442, 446, 448, or 450 in FIG. 4. In an example, 1004 may be performed by the DC component 198.

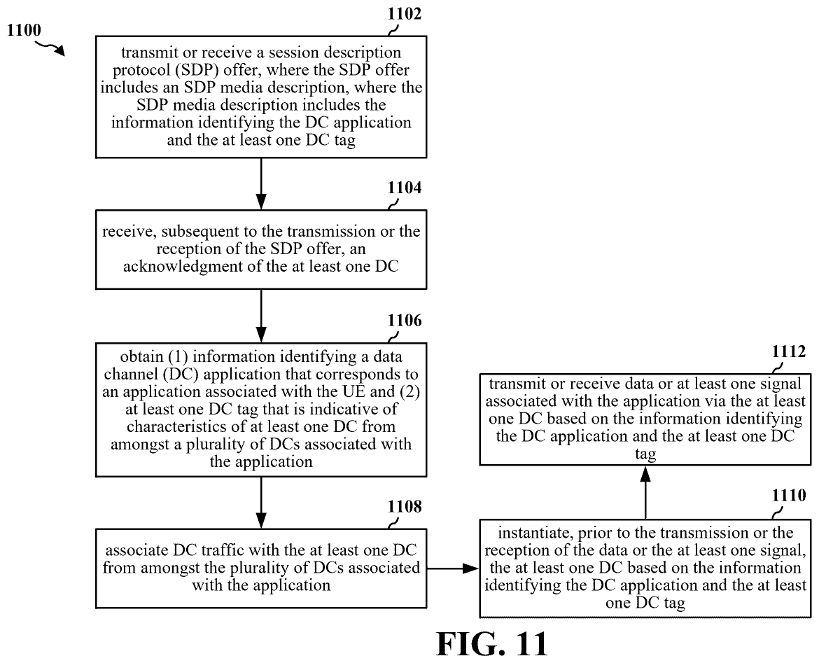

FIG. 11 is a flowchart 1100 of a method of wireless communication. The method may be performed by a UE (e.g., the UE 104, the UE 350, the first UE 402, the second UE 414, the UE 902, the apparatus 1404). The method may be associated with various advantages at the UE, such as more efficient negotiation and establishment of DC(s) for an application vis-à-vis a DC tag. In an example, the method (including the various aspects described below) may be performed by the DC component 198.

At 1106, the UE obtains (1) information identifying a DC application that corresponds to an application associated with the UE and (2) at least one DC tag that is indicative of characteristics of at least one DC from amongst a plurality of DCs associated with the application. For example, FIG. 9 at 912 shows that the UE 902 may obtain a DC app ID (e.g., “information identifying a DC application”) and DC tag(s) that are associated with a DC app. In an example, the application may be the DC application 520. In another example, the at least one DC tag may include the one or more DC tags 510. In yet another example, the UE may obtain the DC application identifier (e.g., “information identifying a DC application”) and the at least one tag when a bootstrap DC is established as illustrated at 416A or 416B in FIG. 4. In a further example, the UE may obtain the DC application identifier (e.g., “information identifying a DC application”) and the at least one tag at 432 as illustrated in FIG. 4. In an example, 1106 may be performed by the DC component 198.

At 1112, the UE transmits or receives data or at least one signal associated with the application via the at least one DC based on the information identifying the DC application and the at least one DC tag. For example, FIG. 9 at 932 shows that the UE 902 may transmit data/signal(s) associated with a DC application via DC(s) based on a DC app ID and DC tag(s). In another example, FIG. 9 at 934 shows that the UE 902 may receive data/signal(s) associated with a DC application via DC(s) based on a DC app ID and DC tag(s). In yet another example, the UE may transmit or receive the data or the at least one signal via one of the DCs established at 442, 442, 446, 448, or 450 in FIG. 4. In an example, 1112 may be performed by the DC component 198.

In one aspect, the characteristics of the at least one DC may be indicative of a data route associated with the application. For example, the data route associated with the application may be a direct UE to UE (e.g., the first UE 402 and the second UE 414) DC connection 512, anchoring a DC in a DC server 514 (e.g., the first DC server 406, the second DC server 412), forwarding DC streams to/from a third party web RTC application 516, and/or forwarding DC streams to/from an application server 518 (e.g., the first IMS AS 404, the second IMS AS 410, the third AS 408).

In one aspect, the data route may include: a direct DC connection between the UE and a second UE, an anchor of the at least one DC in a DC server, a first forward of DC streams to or from a web RTC application, or a second forward of the DC streams to or from an application server. For example, the data route may include a direct UE to UE (e.g., the first UE 402 and the second UE 414) DC connection 512, anchoring a DC in a DC server 514 (e.g., the first DC server 406, the second DC server 412), forwarding DC streams to/from a third party web RTC application 516, and/or forwarding DC streams to/from an application server 518 (e.g., the first IMS AS 404, the second IMS AS 410, the third AS 408). In another example, the data route may correspond to the DC established at 442, 444, 446, 448, or 450 in FIG. 5. In yet another example, the DC server may be the first DC server 406 or the second DC server 412. In a further example, the application server may be the first IMS AS 404 or the second IMS AS 410. In an example, the third party web RTC application may be associated with the third AS 408.

In one aspect, the DC server may include: a DCS-M function, a DCSF, or a MRF. For example, the first DC server 406 and/or the second DC server 412 may include a DCS-M function, a DCSF, or a MRF.

In one aspect, at 1102, the UE may transmit or receive a SDP offer, where the SDP offer may include a SDP media description, where the SDP media description may include the information identifying the DC application and the at least one DC tag. For example, the SDP offer may be the SDP offer 502, the SDP media description may be the SDP media description 504, the DC application identifier (e.g., “the information identifying the DC application”) may be the DC application identifier 506, and the at least one DC tag may be the one or more DC tags 510. In another example, the SDP offer may be a SDP offer transmitted at 418 or received at 432 as illustrated in FIG. 4. In an example, 1102 may be performed by the DC component 198.

In one aspect, the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description. For example, the first example 602, the second example 604, and/or the third example 606 in FIG. 6 show that the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description.

In one aspect, the information identifying the DC application and the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description. For example, the first example 702, the second example 704, and/or the third example 706 in FIG. 7 show that the DC application identifier (e.g., “the information identifying the DC application”) and the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description

In one aspect, the information identifying the DC application may be indicated by: at least one first attribute associated with a DCSA of the SDP media description, or at least one second attribute associated with a data channel media attribute of the SDP media description, where the at least one DC tag may be indicated by: at least one label parameter associated with the at least one first attribute or the at least one second attribute, or at least one parameter associated with the at least one first attribute or the at least one second attribute, where the at least one parameter is different than the at least one label parameter. For example, the first example 802, the second example 804, the third example 806, the fourth example 808, the fifth example 810, and/or the sixth example 812 show that the DC application identifier (e.g., “the information identifying the DC application”) may be indicated by: at least one first attribute associated with a DCSA of the SDP media description, or at least one second attribute associated with a data channel media attribute of the SDP media description, where the at least one DC tag may be indicated by: at least one label parameter associated with the at least one first attribute or the at least one second attribute, or at least one parameter associated with the at least one first attribute or the at least one second attribute, where the at least one parameter is different than the at least one label parameter.

In one aspect, at 1104, the UE may receive, subsequent to the transmission or the reception of the SDP offer, an acknowledgment of the at least one DC. For example, FIG. 4 at 440 shows that the first UE 402 may receive an OK message after transmitting a SDP offer at 418. In an example, 1104 may be performed by the DC component 198.

In one aspect, at 1110, the UE may instantiate, prior to the transmission or the reception of the data or the at least one signal, the at least one DC based on the information identifying the DC application and the at least one DC tag. For example, FIG. 9 at 928 shows that the UE 902 may instantiate DC(s) based on a DC app ID and DC tag(s). In an example, instantiating at least one DC may include aspects related to establishing the DCs at 442, 444, 446, 448, and/or 450 in FIG. 4. In an example, 1110 may be performed by the DC component 198.

In one aspect, the information identifying the DC application and the at least one DC tag may be obtained via a bootstrap DC. For example, the DC application identifier (e.g., “the information identifying the DC application”) and the at least one DC tag may be obtained via the bootstrap DC established at 416A in FIG. 4 or the bootstrap DC established at 416B in FIG. 4.

In one aspect, obtaining the information identifying the DC application and the at least one DC tag may include receiving a DC application list, where the information identifying the DC application and the at least one DC tag may be included in the DC application list. For example, FIG. 9 at 918 shows that the UE 902 may obtain a DC app ID (e.g., “the information identifying the DC application”) and DC tag(s) by receiving a DC application list.

In one aspect, obtaining the information identifying the DC application and the at least one DC tag may include receiving the application along with the information identifying the DC application and the at least one DC tag. For example, FIG. 9 at 914 shows that the UE 902 may obtain a DC app ID (e.g., “the information identifying the DC application”) and DC tag(s) by receiving a DC application.

In one aspect, the at least one DC may include a first DC associated with a UE-based render of first content associated with the application and a second DC associated with a network based render of second content associated with the application. For example, FIG. 5 shows that the at least one DC may include a first DC associated with a UE-based render of first content associated with the DC application 520 and a second DC associated with a network based render of second content associated with the DC application 520.

In one aspect, at 1108, the UE may associate DC traffic with the at least one DC from amongst the plurality of DCs associated with the application. For example, FIG. 9 at 930 shows that the UE 902 may associate DC traffic with DC(s) associated with a DC application. In an example, 1108 may be performed by the DC component 198.

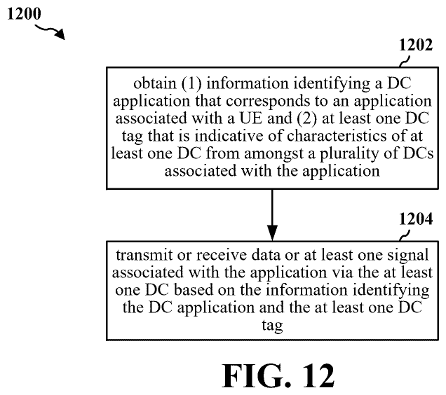

FIG. 12 is a flowchart 1200 of a method of wireless communication. The method may be performed by a network entity (e.g., the base station 102, the base station 310, the base station 904, the network entity 1502). The method may be associated with various advantages at the network entity, such as more efficient negotiation of DCs for DC applications. In an example, the method may be performed by the DC component 199.

At 1202, the network entity obtains (1) information identifying a DC application that corresponds to an application associated with a UE and (2) at least one DC tag that is indicative of characteristics of at least one DC from amongst a plurality of DCs associated with the application. For example, FIG. 9 at 922 shows that the base station 904 may obtain a DC app ID (e.g., “the information identifying the DC application”) and DC tag(s) associated with a DC application. In an example, the application may be the DC application 520. In another example, the at least one DC tag may include the one or more DC tags 510. In another example, the network entity may obtain the DC application identifier (e.g., “the information identifying the DC application”) and the at least one DC tag at 420 or at 428 as illustrated in FIG. 4. In an example, 1202 may be performed by the DC component 199.

At 1204, the network entity transmits or receives data or at least one signal associated with the application via the at least one DC based on the information identifying the DC application and the at least one DC tag. For example, FIG. 9 at 932 shows that the base station 904 may receive data/signal(s) associated with a DC application via DC(s) based on a DC app ID (e.g., “the information identifying the DC application”) and DC tag(s). In another example, FIG. 9 at 934 shows that the base station 904 may transmit data/signal(s) associated with a DC application via DC(s) based on a DC app ID (e.g., “the information identifying the DC application”) and DC tag(s). In yet another example, the network entity may transmit or receive the data or the at least one signal via one of the DCs established at 442, 442, 446, 448, or 450 in FIG. 4. In an example, 1204 may be performed by the DC component 199.

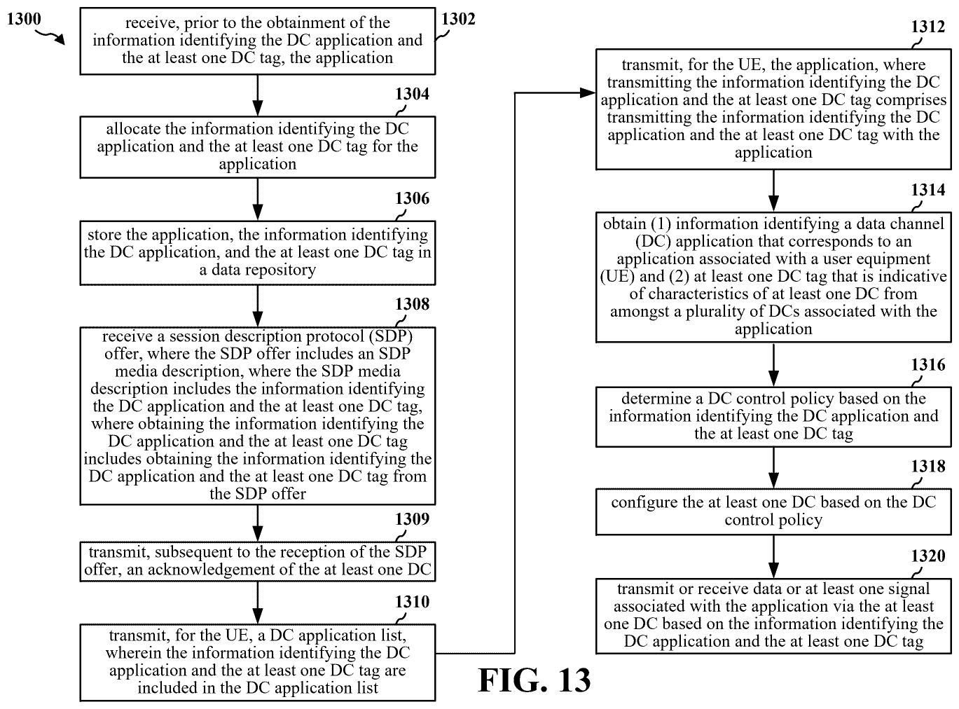

FIG. 13 is a flowchart 1300 of a method of wireless communication. The method may be performed by a network entity (e.g., the base station 102, the base station 310, the base station 904, the network entity 1502). The method may be associated with various advantages at the network entity, such as more efficient negotiation of DCs for DC applications. In an example, the method (including the various aspects described below) may be performed by the DC component 199.

At 1314, the network entity obtains (1) information identifying a DC application that corresponds to an application associated with a UE and (2) at least one DC tag that is indicative of characteristics of at least one DC from amongst a plurality of DCs associated with the application. For example, FIG. 9 at 922 shows that the base station 904 may obtain a DC app ID (e.g., “the information identifying the DC application”) and DC tag(s) associated with a DC application. In an example, the application may be the DC application 520. In another example, the at least one DC tag may include the one or more DC tags 510. In another example, the network entity may obtain the DC application identifier (e.g., “the information identifying the DC application”) and the at least one DC tag at 420 or at 428 as illustrated in FIG. 4. In an example, 1314 may be performed by the DC component 199.

At 1320, the network entity transmits or receives data or at least one signal associated with the application via the at least one DC based on the information identifying the DC application and the at least one DC tag. For example, FIG. 9 at 932 shows that the base station 904 may receive data/signal(s) associated with a DC application via DC(s) based on a DC app ID (e.g., “the information identifying the DC application”) and DC tag(s). In another example, FIG. 9 at 934 shows that the base station 904 may transmit data/signal(s) associated with a DC application via DC(s) based on a DC app ID (e.g., “the information identifying the DC application”) and DC tag(s). In yet another example, the network entity may transmit or receive the data or the at least one signal via one of the DCs established at 442, 442, 446, 448, or 450 in FIG. 4. In an example, 1320 may be performed by the DC component 199.

In one aspect, the characteristics of the at least one DC tag may be indicative of a data route associated with the application. For example, the data route associated with the application may be a direct UE to UE (e.g., the first UE 402 and the second UE 414) DC connection 512, anchoring a DC in a DC server 514 (e.g., the first DC server 406, the second DC server 412), forwarding DC streams to/from a third party web RTC application 516, and/or forwarding DC streams to/from an application server 518 (e.g., the first IMS AS 404, the second IMS AS 410, the third AS 408).

In one aspect, the data route may include: a direct DC connection between the UE and a second UE, an anchor of the at least one DC in a DC server, a first forward of DC streams to or from a web RTC application, or a second forward of the DC streams to or from an application server. For example, the data route may include a direct UE to UE (e.g., the first UE 402 and the second UE 414) DC connection 512, anchoring a DC in a DC server 514 (e.g., the first DC server 406, the second DC server 412), forwarding DC streams to/from a third party web RTC application 516, and/or forwarding DC streams to/from an application server 518 (e.g., the first IMS AS 404, the second IMS AS 410, the third AS 408). In another example, the data route may correspond to the DC established at 442, 444, 446, 448, or 450 in FIG. 5. In yet another example, the DC server may be the first DC server 406 or the second DC server 412. In a further example, the application server may be the first IMS AS 404 or the second IMS AS 410. In an example, the third party web RTC application may be associated with the third AS 408.

In one aspect, the DC server may include: a DCS-M function, a DCSF, or a MRF. For example, the first DC server 406 and/or the second DC server 412 may include a DCS-M function, a DCSF, or a MRF.

In one aspect, at 1308, the network entity may receive a SDP offer, where the SDP offer may include a SDP media description, where the SDP media description may include the information identifying the DC application and the at least one DC tag, where the information identifying the DC application and the at least one DC tag may be obtained from the SDP offer. For example, the SDP offer may be the SDP offer 502, the SDP media description may be the SDP media description 504, the DC application identifier (e.g., “the information identifying the DC application”) may be the DC application identifier 506, and the at least one DC tag may be the one or more DC tags 510. In another example, the SDP offer may be a SDP offer received at 420 or 428. In an example, 1308 may be performed by the DC component 199.

In one aspect, the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description. For example, the first example 602, the second example 604, and/or the third example 606 in FIG. 6 show that the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description.

In one aspect, the information identifying the DC application and the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description. For example, the first example 702, the second example 704, and/or the third example 706 in FIG. 7 show that the DC application identifier (e.g., “the information identifying the DC application”) and the at least one DC tag may be indicated by: at least one label parameter in the SDP media description, or at least one parameter in the SDP media description, where the at least one parameter is different than the at least one label parameter, where the at least one parameter is associated with a DCSA of the SDP media description or a data channel media attribute of the SDP media description.

In one aspect, the information identifying the DC application may be indicated by: at least one first attribute associated with a DCSA of the SDP media description, or at least one second attribute associated with a data channel media attribute of the SDP media description, where the at least one DC tag is indicated by: at least one label parameter associated with the at least one first attribute or the at least one second attribute, or at least one parameter associated with the at least one first attribute or the at least one second attribute, where the at least one parameter is different than the at least one label parameter. For example, the first example 802, the second example 804, the third example 806, the fourth example 808, the fifth example 810, and/or the sixth example 812 show that the DC application identifier (e.g., “the information identifying the DC application”) may be indicated by: at least one first attribute associated with a DCSA of the SDP media description, or at least one second attribute associated with a data channel media attribute of the SDP media description, where the at least one DC tag may be indicated by: at least one label parameter associated with the at least one first attribute or the at least one second attribute, or at least one parameter associated with the at least one first attribute or the at least one second attribute, where the at least one parameter is different than the at least one label parameter.

In one aspect, at 1309, the network entity may transmit, subsequent to the reception of the SDP offer, an acknowledgment of the at least one DC. For example, FIG. 4 at 440 shows that the first DC server 406 may transmit an OK message. In an example, 1309 may be performed by the DC component 199.

In one aspect, the information identifying the DC application and the at least one DC tag may be received via a bootstrap DC. For example, the DC application identifier and (e.g., “the information identifying the DC application”) the at least one DC tag may be obtained via the bootstrap DC established at 416A in FIG. 4 or the bootstrap DC established at 416B in FIG. 4.

In one aspect, at 1310, the network entity may transmit, for the UE, a DC application list, where the information identifying the DC application and the at least one DC tag may be included in the DC application list. For example, FIG. 9 at 920 shows that the base station 904 may transmit a DC application list that may include the DC application identifier (e.g., “the information identifying the DC application”) and the at least one DC tag. In an example, 1310 may be performed by the DC component 199.

In one aspect, at 1312, the network entity may transmit, for the UE, the application, where the information identifying the DC application and the at least one DC tag may be transmitted with the application. For example, FIG. 9 at 916 shows that the base station 904 may transmit a DC application that includes a DC application identifier (e.g., “the information identifying the DC application”) and DC tag(s). In an example, 1312 may be performed by the DC component 199.

In one aspect, the at least one DC may include a first DC associated with a UE-based render of first content associated with the application and a second DC associated with a network based render of second content associated with the application. For example, FIG. 5 shows that the at least one DC may include a first DC associated with a UE-based render of first content associated with the DC application 520 and a second DC associated with a network based render of second content associated with the DC application 520.

In one aspect, at 1316, the network entity may determine a DC control policy based on the information identifying the DC application and the at least one DC tag. For example, FIG. 9 at 924 shows that the base station 904 may determine a DC control policy based on a DC application ID (e.g., “the information identifying the DC application”) and DC tag(s). In an example, 1316 may be performed by the DC component 199.

In one aspect, at 1318, the network entity may configure the at least one DC based on the DC control policy. For example, FIG. 9 at 926 shows that the base station 904 may configure DC(s) based on the DC control policy determined at 924. In an example, configuring the one or more DCs may include aspects related to establishing the DCs at 442, 444, 446, 448, and/or 450 in FIG. 4. In an example, 1318 may be performed by the DC component 199.

In one aspect, at 1302, the network entity may receive, prior to obtaining the information identifying the DC application and the at least one DC tag, the application. For example, FIG. 9 at 906 shows that the base station 904 may obtain a DC application. In an example, 1302 may be performed by the DC component 199.

In one aspect, at 1304, the network entity may allocate the information identifying the DC application and the at least one DC tag for the application. For example, FIG. 9 at 908 shows that the base station 904 may allocate a DC application ID (e.g., “the information identifying the DC application”) and DC tag(s) for a DC application. In an example, 1304 may be performed by the DC component 199.

In one aspect, at 1306, the network entity may store the application, the information identifying the DC application, and the at least one DC tag in a data repository. For example, FIG. 9 at 910 shows that the base station 904 may store a DC application, a DC application ID (e.g., “the information identifying the DC application”), and DC tag(s) in a DC application repository. In an example, 1306 may be performed by the DC component 199.

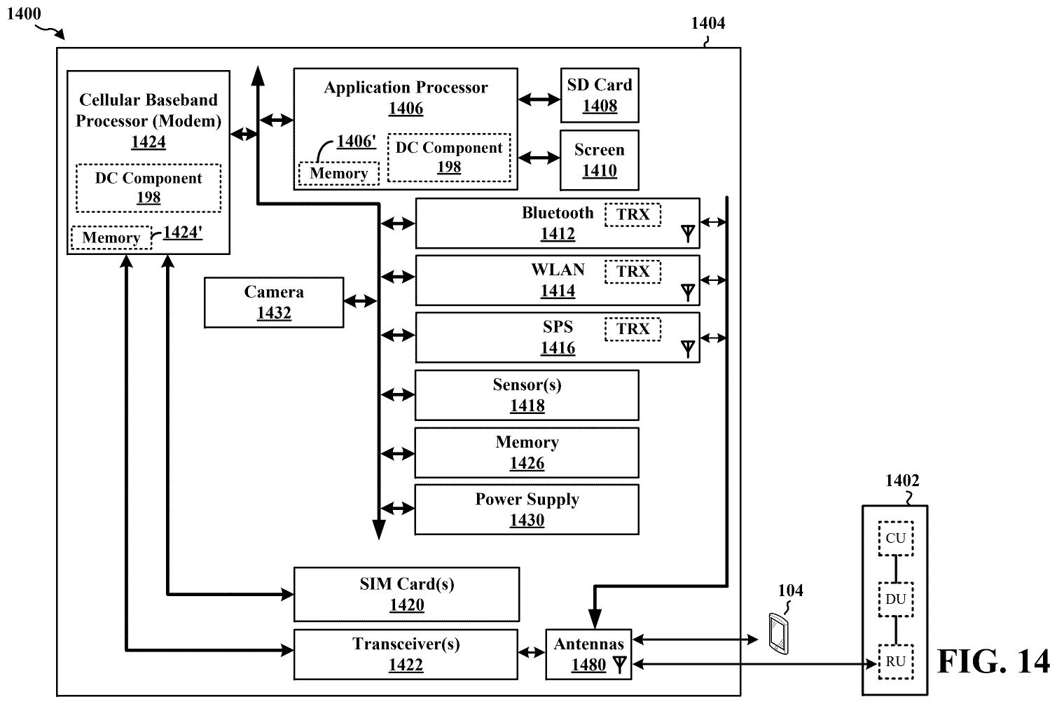

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor 1406 may include at least one on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with a network entity 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1424/application processor 1406 when executing software. The cellular baseband processor 1424/application processor 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the DC component 198 is configured to obtain (1) information identifying a DC application that corresponds to an application associated with the UE and (2) at least one DC tag that is indicative of characteristics of at least one DC from amongst a plurality of DCs associated with the application. The DC component 198 is configured to transmit or receive data or at least one signal associated with the application via the at least one DC based on the information identifying the DC application and the at least one DC tag. The DC component 198 may be configured to transmit or receive a SDP offer, where the SDP offer includes a SDP media description, where the SDP media description includes the information identifying the DC application and the at least one DC tag. The DC component 198 may be configured to receive, subsequent to the transmission or the reception of the SDP offer, an acknowledgment of the at least one DC. The DC component 198 may be configured to instantiate, prior to the transmission or the reception of the data or the at least one signal, the at least one DC based on the information identifying the DC application and the at least one DC tag. To obtain the information identifying the DC application and the at least one DC tag, the DC component 198 may be configured to receive a DC application list, where the information identifying the DC application and the at least one DC tag are included in the DC application list. To obtain the information identifying the DC application and the at least one DC tag, the DC component 198 may be configured to receive the application along with the information identifying the DC application and the at least one DC tag. The DC component 198 may be configured to associate DC traffic with the at least one DC from amongst the plurality of DCs associated with the application. The DC component 198 may be within the cellular baseband processor 1424, the application processor 1406, or both the cellular baseband processor 1424 and the application processor 1406. The DC component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor 1424 and/or the application processor 1406, includes means for obtaining (1) information identifying a DC application corresponding to an application associated with the UE and (2) at least one DC tag that is indicative of characteristics of at least one DC from amongst a plurality of DCs associated with the application. In one configuration, the apparatus 1404, and in particular the cellular baseband processor 1424 and/or the application processor 1406, includes means for transmitting or receiving data or at least one signal associated with the application via the at least one DC based on the information identifying the DC application and the at least one DC tag. In one configuration, the apparatus 1404, and in particular the cellular baseband processor 1424 and/or the application processor 1406, includes means for transmitting or receiving a SDP offer, where the SDP offer includes a SDP media description, where the SDP media description includes the information identifying the DC application and the at least one DC tag. In one configuration, the apparatus 1404, and in particular the cellular baseband processor 1424 and/or the application processor 1406, includes means for receiving, subsequent to transmitting or receiving the SDP offer, an acknowledgment of the at least one DC. In one configuration, the apparatus 1404, and in particular the cellular baseband processor 1424 and/or the application processor 1406, includes means for instantiating, prior to transmitting or receiving the data or the at least one signal, the at least one DC based on the information identifying the DC application and the at least one DC tag. In one configuration, the means for obtaining the information identifying the DC application and the at least one DC tag include means for receiving a DC application list, where the information identifying the DC application and the at least one DC tag are included in the DC application list. In one configuration, the means for obtaining the information identifying the DC application and the at least one DC tag include means for receiving the application along with the information identifying the DC application and the at least one DC tag. In one configuration, the apparatus 1404, and in particular the cellular baseband processor 1424 and/or the application processor 1406, includes means for associating DC traffic with the at least one DC from amongst the plurality of DCs associated with the application. The means may be the DC component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

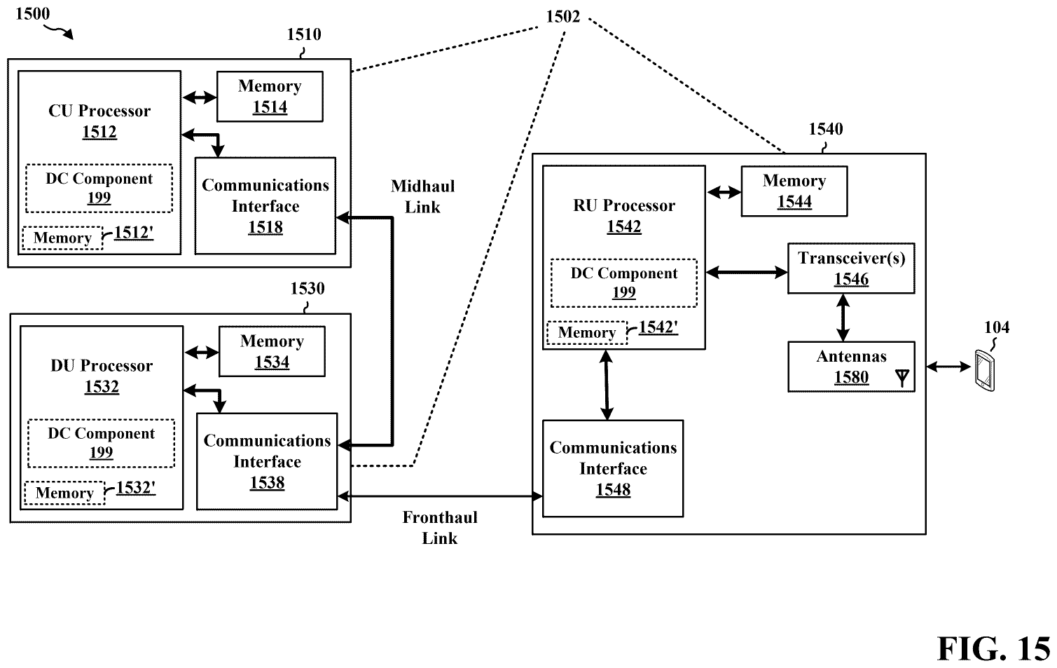

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the DC component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor 1512 may include at least one on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor 1532 may include at least one on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor 1542 may include at least one on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the DC component 199 is configured to obtain (1) information identifying a DC application that corresponds to an application associated with a UE and (2) at least one DC tag that is indicative of characteristics of at least one DC from amongst a plurality of DCs associated with the application. The DC component 199 is configured to transmit or receive data or at least one signal associated with the application via the at least one DC based on the information identifying the DC application and the at least one DC tag. The DC component 199 may be configured to receive a SDP offer, where the SDP offer includes a SDP media description, where the SDP media description includes the information identifying the DC application and the at least one DC tag, where the information identifying the DC application and the at least one DC tag are obtained from the SDP offer. The DC component 199 may be configured to transmit, subsequent to the reception of the SDP offer, an acknowledgment of the at least one DC. The DC component 199 may be configured to transmit, for the UE, a DC application list, where the information identifying the DC application and the at least one DC tag are included in the DC application list. The DC component 199 may be configured to transmit, for the UE, the application, where the information identifying the DC application and the at least one DC tag are transmitted with the application. The DC component 199 may be configured to determine a DC control policy based on the information identifying the DC application and the at least one DC tag. The DC component 199 may be configured to configure the at least one DC based on the DC control policy. The DC component 199 may be configured to receive, prior to the obtainment of the information identifying the DC application and the at least one DC tag, the application. The DC component 199 may be configured to allocate the information identifying the DC application and the at least one DC tag for the application. The DC component 199 may be configured to store the application, the information identifying the DC application, and the at least one DC tag in a data repository. The DC component 199 may be within one or more processors of one or more of the CU 1510, DU 1530, and the RU 1540. The DC component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for obtaining (1) information identifying a DC application corresponding to an application associated with a UE and (2) at least one DC tag that is indicative of characteristics of at least one DC from amongst a plurality of DCs associated with the application. In one configuration, the network entity 1502 includes means for transmitting or receiving data or at least one signal associated with the application via the at least one DC based on the information identifying the DC application and the at least one DC tag. In one configuration, the network entity 1502 includes means for receiving a SDP offer, where the SDP offer includes a SDP media description, where the SDP media description includes the information identifying the DC application and the at least one DC tag, where the information identifying the DC application and the at least one DC tag are obtained from the SDP offer. In one configuration, the network entity 1502 includes means for transmitting, subsequent to receiving the SDP offer, an acknowledgment of the at least one DC. In one configuration, the network entity 1502 includes means for transmitting, for the UE, a DC application list, where the information identifying the DC application and the at least one DC tag are included in the DC application list. In one configuration, the network entity 1502 includes means for transmitting, for the UE, the application, where the information identifying the DC application and the at least one DC tag are transmitted with the application. In one configuration, the network entity 1502 includes means for determining a DC control policy based on the information identifying the DC application and the at least one DC tag. In one configuration, the network entity 1502 includes means for configuring the at least one DC based on the DC control policy. In one configuration, the network entity 1502 includes means for receiving, prior to obtaining the information identifying the DC application and the at least one DC tag, the application. In one configuration, the network entity 1502 includes means for allocating the information identifying the DC application and the at least one DC tag for the application. In one configuration, the network entity 1502 includes means for storing the application, the information identifying the DC application, and the at least one DC tag in a data repository. The means may be the DC component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

An application may support more than one DC for transmission/reception of traffic associated with the application. For example, an AR application in a IMS DC may support UE-based AR rendering and network based AR rendering. In such an example, a UE may request (e.g., in a SDP media description of a SDP offer) multiple DCs with different traffic routes for the (same) application. In an example, a route may include a direct DC connection between two UEs, anchoring a DC in a DC server, forwarding DC streams to/from a web RTC application, or forwarding DC streams to/from an application server (e.g., an AR server). A DCSF may determine a corresponding DC control policy for each DC requested in the SDP media description. However, a DC application ID included in the SDP offer may not include information that indicates characteristics (i.e., routes) of each DC. As such, the DCSF may not be able to establish multiple DCs based on the DC application ID. The DCSF may look up a route selection based on the DC application ID to ascertain a route for each DC.

Various technologies pertaining to extending a DC application ID with a DC tag are described herein. In an example, a UE obtains information identifying a DC application that corresponds to an application associated with the UE and at least one DC tag that is indicative of characteristics of at least one DC from amongst a plurality of DCs associated with the application. The UE transmits or receives data or at least one signal associated with the application via the at least one DC based on the information identifying the DC application and the at least one DC tag. Vis-à-vis the at least one DC tag, the multiple DCs may be established for the application without the use of additional signaling and without utilizing a route look up. Thus, the aforementioned technologies may conserve network resources.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), including: obtaining (1) information identifying a data channel (DC) application corresponding to an application associated with the UE and (2) at least one DC tag that is indicative of characteristics of at least one DC from amongst a plurality of DCs associated with the application; and transmitting or receiving data or at least one signal associated with the application via the at least one DC based on the information identifying the DC application and the at least one DC tag.

Aspect 2 is the method of aspect 1, where the characteristics of the at least one DC are indicative of a data route associated with the application.

Aspect 3 is the method of aspect 2, where the data route includes: a direct DC connection between the UE and a second UE, anchoring the at least one DC in a DC server, forwarding DC streams to or from a web real-time communication (RTC) application, or forwarding the DC streams to or from an application server.

Aspect 4 is the method of aspect 3, where the application server is an augmented reality (AR) server.

Aspect 5 is the method of any of aspects 3-4, where the DC server includes: a data channel server-media (DCS-M) function, a control function of a data channel server (DCSF), or a media resource function (MRF).

Aspect 6 is the method of any of aspects 1-5, further including: transmitting or receiving a session description protocol (SDP) offer, where the SDP offer includes an SDP media description, where the SDP media description includes the information identifying the DC application and the at least one DC tag.

Aspect 7 is the method of aspect 6, where the at least one DC tag is indicated by: at least one label parameter in the SDP media description, or at least one parameter in the SDP media description, where the at least one parameter is different than the at least one label parameter, where the at least one parameter is associated with a data channel subprotocol attribute (DCSA) of the SDP media description or a data channel media attribute of the SDP media description.

Aspect 8 is the method of aspect 6, where the information identifying the DC application and the at least one DC tag are indicated by: at least one label parameter in the SDP media description, or at least one parameter in the SDP media description, where the at least one parameter is different than the at least one label parameter, where the at least one parameter is associated with a data channel subprotocol attribute (DCSA) of the SDP media description or a data channel media attribute of the SDP media description.

Aspect 9 is the method of aspect 6, where the information identifying the DC application is indicated by: at least one first attribute associated with a data channel subprotocol attribute (DCSA) of the SDP media description, or at least one second attribute associated with a data channel media attribute of the SDP media description, where the at least one DC tag is indicated by: at least one label parameter associated with the at least one first attribute or the at least one second attribute, or at least one parameter associated with the at least one first attribute or the at least one second attribute, where the at least one parameter is different than the at least one label parameter.

Aspect 10 is the method of any of aspects 1-9, further including: receiving, subsequent to transmitting or receiving the SDP offer, an acknowledgment of the at least one DC.

Aspect 11 is the method of aspect 10, further including: instantiating, prior to transmitting or receiving the data or the at least one signal, the at least one DC based on the information identifying the DC application and the at least one DC tag.

Aspect 12 is the method of any of aspects 1-11, where the information identifying the DC application and the at least one DC tag are obtained via a bootstrap DC.

Aspect 13 is the method of any of aspects 1-12, where obtaining the information identifying the DC application and the at least one DC tag includes: receiving a DC application list, where the information identifying the DC application and the at least one DC tag are included in the DC application list.

Aspect 14 is the method of any of aspects 1-12, where obtaining the information identifying the DC application and the at least one DC tag includes: receiving the application along with the information identifying the DC application and the at least one DC tag.

Aspect 15 is the method of any of aspects 1-14, where the at least one DC includes a first DC associated with UE-based rendering of first content associated with the application and a second DC associated with network based rendering of second content associated with the application.

Aspect 16 is the method of any of aspects 1-15, further including: associating DC traffic with the at least one DC from amongst the plurality of DCs associated with the application.

Aspect 17 is an apparatus for wireless communication at a UE including at least one memory and at least one processor coupled to the at least one memory and based at least in part on information stored in the at least one memory, the at least one processor, individually or in any combination, is configured to cause the UE to perform a method in accordance with any of aspects 1-16.

Aspect 18 is an apparatus for wireless communications, including means for performing a method in accordance with any of aspects 1-16.

Aspect 19 is the apparatus of aspect 17 or 18 further including at least one of a transceiver or an antenna coupled to the at least one processor, where the at least one processor, individually or in any combination, is configured to transmit or receive the data or the at least one signal via at least one of the transceiver or the antenna.

Aspect 20 is a computer-readable medium (e.g., a non-transitory computer-readable medium) including instructions that, when executed by at least one processor, cause a UE to perform a method in accordance with any of aspects 1-16.

Aspect 21 is the method of wireless communication at a network entity, including: obtaining (1) information identifying a data channel (DC) application corresponding to an application associated with a user equipment (UE) and (2) at least one DC tag that is indicative of characteristics of at least one DC from amongst a plurality of DCs associated with the application; and transmitting or receiving data or at least one signal associated with the application via the at least one DC based on the information identifying the DC application and the at least one DC tag.

Aspect 22 is the method of aspect 21, where the characteristics of the at least one DC tag are indicative of a data route associated with the application.

Aspect 23 is the method of aspect 22, where the data route includes: a direct DC connection between the UE and a second UE, anchoring the at least one DC in a DC server, forwarding DC streams to or from a web real-time communication (RTC) application, or forwarding the DC streams to or from an application server.

Aspect 24 is the method of aspect 23, where the application server is an augmented reality (AR) server.

Aspect 25 is the method of any of aspects 23-24, where the DC server includes: a data channel server-media (DCS-M) function, a control function of a data channel server (DCSF), or a media resource function (MRF).

Aspect 26 is the method of any of aspects 21-26, further including: receiving a session description protocol (SDP) offer, where the SDP offer includes an SDP media description, where the SDP media description includes the information identifying the DC application and the at least one DC tag, where the information identifying the DC application and the at least one DC tag are obtained from the SDP offer.

Aspect 27 is the method of aspect 26, where the at least one DC tag is indicated by: at least one label parameter in the SDP media description, or at least one parameter in the SDP media description, where the at least one parameter is different than the at least one label parameter, where the at least one parameter is associated with a data channel subprotocol attribute (DCSA) of the SDP media description or a data channel media attribute of the SDP media description.

Aspect 28 is the method of aspect 26, where the information identifying the DC application and the at least one DC tag are indicated by: at least one label parameter in the SDP media description, or at least one parameter in the SDP media description, where the at least one parameter is different than the at least one label parameter, where the at least one parameter is associated with a data channel subprotocol attribute (DCSA) of the SDP media description or a data channel media attribute of the SDP media description.

Aspect 29 is the method of aspect 26, where the information identifying the DC application is indicated by: at least one first attribute associated with a data channel subprotocol attribute (DCSA) of the SDP media description, or at least one second attribute associated with a data channel media attribute of the SDP media description, where the at least one DC tag is indicated by: at least one label parameter associated with the at least one first attribute or the at least one second attribute, or at least one parameter associated with the at least one first attribute or the at least one second attribute, where the at least one parameter is different than the at least one label parameter.

Aspect 30 is the method of any of aspects 26-29, further including: transmitting, subsequent to receiving the SDP offer, an acknowledgment of the at least one DC.

Aspect 31 is the method of any of aspects 21-30, where the information identifying the DC application and the at least one DC tag are received via a bootstrap DC.

Aspect 32 is the method of any of aspects 21-31, further including: transmitting, for the UE, a DC application list, where the information identifying the DC application and the at least one DC tag are included in the DC application list.

Aspect 33 is the method of any of aspects 21-32, further including: transmitting, for the UE, the application, where the information identifying the DC application and the at least one DC tag are transmitted with the application.

Aspect 34 is the method of any of aspects 21-33, where the at least one DC includes a first DC associated with UE-based rendering of first content associated with the application and a second DC associated with network based rendering of second content associated with the application.

Aspect 35 is the method of any of aspects 21-34, further including: determining a DC control policy based on the information identifying the DC application and the at least one DC tag; and configuring the at least one DC based on the DC control policy.

Aspect 36 is the method of any of aspects 21-35, further including: receiving, prior to obtaining the information identifying the DC application and the at least one DC tag, the application; allocating the information identifying the DC application and the at least one DC tag for the application; and storing the application, the information identifying the DC application, and the at least one DC tag in a data repository.

Aspect 37 is an apparatus for wireless communication at a network entity including at least one memory and at least one processor coupled to the at least one memory and based at least in part on information stored in the at least one memory, the at least one processor, individually or in any combination, is configured to cause the network entity to perform a method in accordance with any of aspects 21-36.

Aspect 38 is an apparatus for wireless communications, including means for performing a method in accordance with any of aspects 21-36.

Aspect 39 is the apparatus of aspect 37 or 38 further including at least one of a transceiver or an antenna coupled to the at least one processor, where the at least one processor, individually or in any combination, is configured to transmit or receive the data or the at least one signal via at least one of the transceiver or the antenna.

Aspect 40 is a computer-readable medium (e.g., a non-transitory computer-readable medium) including instructions that, when executed by at least one processor, cause a network entity to perform a method in accordance with any of aspects 21-36.

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to cause the UE to:
obtain (1) information identifying a data channel (DC) application that corresponds to an application associated with the UE and (2) at least one DC tag that is indicative of characteristics of at least one DC from amongst a plurality of DCs associated with the application; and
transmit or receive data or at least one signal associated with the application via the at least one DC based on the information identifying the DC application and the at least one DC tag.

2. The apparatus of claim 1, wherein the characteristics of the at least one DC are indicative of a data route associated with the application.

3. The apparatus of claim 2, wherein the data route includes:
a direct DC connection between the UE and a second UE,
an anchor of the at least one DC in a DC server,
a first forward of DC streams to or from a web real-time communication (RTC) application, or
a second forward of the DC streams to or from an application server.

4. The apparatus of claim 3, wherein the DC server includes:
a data channel server-media (DCS-M) function,
a data channel media function (DCMF), or
a media resource function (MRF).

5. The apparatus of claim 1, wherein the at least one processor, individually or in any combination, is further configured to cause the UE to:
transmit or receive a session description protocol (SDP) offer, wherein the SDP offer includes an SDP media description, wherein the SDP media description includes the information identifying the DC application and the at least one DC tag.

6. The apparatus of claim 5, wherein the at least one DC tag is indicated by:
at least one label parameter in the SDP media description, or
at least one parameter in the SDP media description, wherein the at least one parameter is different than the at least one label parameter, wherein the at least one parameter is associated with a data channel subprotocol attribute (DCSA) of the SDP media description or a data channel media attribute of the SDP media description.

7. The apparatus of claim 5, wherein the information identifying the DC application and the at least one DC tag are indicated by:
at least one label parameter in the SDP media description, or
at least one parameter in the SDP media description, wherein the at least one parameter is different than the at least one label parameter, wherein the at least one parameter is associated with a data channel subprotocol attribute (DCSA) of the SDP media description or a data channel media attribute of the SDP media description.

8. The apparatus of claim 5, wherein the information identifying the DC application is indicated by:
at least one first attribute associated with a data channel subprotocol attribute (DCSA) of the SDP media description, or
at least one second attribute associated with a data channel media attribute of the SDP media description,
wherein the at least one DC tag is indicated by:
at least one label parameter associated with the at least one first attribute or the at least one second attribute, or
at least one parameter associated with the at least one first attribute or the at least one second attribute, wherein the at least one parameter is different than the at least one label parameter.

9. The apparatus of claim 5, wherein the at least one processor, individually or in any combination, is further configured to cause the UE to:
receive, subsequent to transmission or reception of the SDP offer, an acknowledgment of the at least one DC.

10. The apparatus of claim 9, wherein the at least one processor, individually or in any combination, is further configured to cause the UE to:
instantiate, prior to the transmission or the reception of the data or the at least one signal, the at least one DC based on the information identifying the DC application and the at least one DC tag.

11. The apparatus of claim 1, wherein to obtain the information identifying the DC application and the at least one DC tag, the at least one processor, individually or in any combination, is configured to obtain the information identifying the DC application and the at least one DC tag via a bootstrap DC.

12. The apparatus of claim 1, wherein to obtain the information identifying the DC application and the at least one DC tag, the at least one processor, individually or in any combination, is further configured to cause the UE to:
receive a DC application list, wherein the information identifying the DC application and the at least one DC tag are included in the DC application list.

13. The apparatus of claim 1, wherein to obtain the information identifying the DC application and the at least one DC tag, the at least one processor, individually or in any combination, is further configured to:
receive the application along with the information identifying the DC application and the at least one DC tag.

14. The apparatus of claim 1, wherein the at least one DC includes a first DC associated with a UE-based render of first content associated with the application and a second DC associated with a network based render of second content associated with the application.

15. The apparatus of claim 1, wherein the at least one processor, individually or in any combination, is further configured to cause the UE to:
associate DC traffic with the at least one DC from amongst the plurality of DCs associated with the application.

16. The apparatus of claim 1, further comprising: at least one of a transceiver or an antenna coupled to the at least one processor, wherein the at least one processor, individually or in any combination, is configured to cause the UE to transmit or receive the data or the at least one signal via at least one of the transceiver or the antenna.

17. A method of wireless communication at a user equipment (UE), comprising:
obtaining (1) information identifying a data channel (DC) application corresponding to an application associated with the UE and (2) at least one DC tag that is indicative of characteristics of at least one DC from amongst a plurality of DCs associated with the application; and
transmitting or receiving data or at least one signal associated with the application via the at least one DC based on the information identifying the DC application and the at least one DC tag.

18. An apparatus for wireless communication at a network entity, comprising:
at least one memory; and
at least one processor coupled to the at least one memory and, based at least in part on stored information that is stored in the at least one memory, the at least one processor, individually or in any combination, is configured to cause the network entity to:
obtain (1) information identifying a data channel (DC) application that corresponds to an application associated with a user equipment (UE) and (2) at least one DC tag that is indicative of characteristics of at least one DC from amongst a plurality of DCs associated with the application; and
transmit or receive data or at least one signal associated with the application via the at least one DC based on the information identifying the DC application and the at least one DC tag.

19. The apparatus of claim 18, wherein the characteristics of the at least one DC tag are indicative of a data route associated with the application.

20. The apparatus of claim 19, wherein the data route includes:
a direct DC connection between the UE and a second UE,
an anchor of the at least one DC in a DC server,
a first forward of DC streams to or from a web real-time communication (RTC) application, or
a second forward of the DC streams to or from an application server.

21-30. (canceled)
